(19) United States
(12) Patent Application Publication
(10) Pub. No.: US 2024/0244426 A1
(43) Pub. Date: Jul. 18, 2024

(54) KEY ESTABLISHMENT USING WIRELESS CHANNEL INFORMATION

(71) Applicant: Lenovo (Singapore) Pte. Ltd., New Tech Park (SG)

(72) Inventors: Andreas Kunz, Ladenburg (DE); Seyedomid Taghizadeh Motlagh, Oberursel (DE); Sheeba Backia Mary Baskaran, Friedrichsdorf (DE)

(21) Appl. No.: 18/558,993

(22) PCT Filed: May 3, 2022
(86) PCT No.: PCT/IB2022/054082

§ 371 Date: Nov. 3, 2023

Related U.S. Application Data
(60) Provisional application No. 63/183,500, filed on May 3, 2021.

(51) Int. Cl. H04W 12/041; H04L 9/08

(52) U.S. Cl. CPC H04W 12/041; H04L 9/0875

(57) ABSTRACT

Apparatuses, methods, and systems are disclosed for physical layer secret key generation. One method includes generating a security key using channel information of a wireless channel and computing a first authentication code over a first Training Sequence using the security key. The method includes sending the first Training Sequence including the first authentication code to a second endpoint and receiving a response message from the second endpoint, the response message including a second authentication code. The method includes validating the second authentication code and indicating successful key establishment in response to successful validation of the second authentication code.

### CROSS-REFERENCE TO RELATED APPLICATIONS

This application claims priority to U.S. Provisional Patent Application No. 63/183,500 entitled “MULTIPLE OF PHYSICAL LAYER SECRET KEY GENERATION” and filed on 3 May 2021 for Andreas Kunz, Seyedomid Taghizadeh Motlagh, Sheeba Backia Mary Baskaran, which application is incorporated herein by reference.

### FIELD

The subject matter disclosed herein relates generally to wireless communications and more particularly relates to generating a secret key at the radio physical layer.

### BACKGROUND

Physical Layer Security utilizes the physical layer characteristics of a communication system in order to provide a secure information exchange between two entities.

### BRIEF SUMMARY

Disclosed are procedures for physical layer secret key generation. Said procedures may be implemented by apparatus, systems, methods, or computer program products.

One method at a first wireless endpoint device includes generating a security key using channel information of a wireless channel and computing a first authentication code over a first Training Sequence using the security key. The method includes sending the first Training Sequence including the first authentication code to a second endpoint and receiving a response message from the second endpoint, the response message including a second authentication code. The method includes validating the second authentication code and indicating successful key establishment in response to successful validation of the second authentication code.

One method at a second wireless endpoint device includes receiving a first Training Sequence including a first authentication code from the first endpoint and generating a security key using channel information of the wireless channel. The method includes validating the first authentication code using the generated security key and indicating successful key establishment in response to successful validation of the second authentication code. The method includes computing a second authentication code over a second Training Sequence and sending a response message to the first endpoint, the response message comprising the second authentication code.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for physical layer secret key generation:

FIG. 2 is a diagram illustrating one embodiment of a New Radio (“NR”) protocol stack:

FIG. 3A is a diagram illustrating one embodiment of a general physical layer scheme for secure information exchange:

FIG. 3B is a diagram illustrating one embodiment of a special case of physical layer scheme for secure information exchange:

FIG. 4 is a diagram illustrating one embodiment of encrypting a message using a channel estimate:

FIG. 5 is a diagram illustrating one embodiment of decrypting a message using a channel estimate:

FIG. 6A is a diagram illustrating one embodiment of a key verification procedure:

FIG. 6B is a continuation of the procedure of FIG. 6A:

FIG. 7 is a block diagram illustrating one embodiment of a user equipment apparatus that may be used for physical layer secret key generation:

FIG. 8 is a block diagram illustrating one embodiment of a network apparatus that may be used for physical layer secret key generation;

FIG. 9 is a flowchart diagram illustrating one embodiment of a first method for physical layer secret key generation; and

FIG. 10 is a flowchart diagram illustrating one embodiment of a second method for physical layer secret key generation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for physical layer secret key generation. In certain embodiments, Physical Layer Security utilizes the physical layer characteristics of a communication system in order to provide a secure information exchange between two entities. In a special case, Physical Layer Security tries to make use of the uniqueness of the physical channel between two endpoints of a wireless communication, and thereby utilizes the Channel State Information as a source of a shared secret.

The wireless channel is described by different parameters that can occur, e.g., fading due to path loss, propagation situation, mobility of the end points, multipath effects, etc. In the ideal and theoretical case, the uniqueness and the randomness provide sufficient information in order to encrypt the communication between the two endpoints. An eavesdropper besides or in the middle of the two endpoints would experience a different wireless channel and thus would not be able to decrypt the communication. The problem arises when the perception of the wireless channel is different between the two endpoints, i.e., the “encryption key” does not match to the “decryption key” and the receiver cannot restore the original message from the sender.

In some embodiments, channel information may be quantized in order to be used as a security on the bit layer (e.g., Medium Access Control (“MAC”) layer) of the communication, e.g., with four stages, namely channel probing, quantization, information reconciliation and privacy amplification. However, current solutions do not describe how a key is generated using channel information. Moreover, current solutions are limited to Internet-of-Things (“IoT”) devices and only take into account the Received Signal Strength (“RSS”) and the Channel State Information (“CSI”) as channel information, which is sensitive to a key guessing attack since the parameters as input to the key generation are very limited and could be guessed by a close by eavesdropper. Further, the known IoT scheme does not cover the cases where the endpoints need to operate in Frequency Division Duplex (“FDD”) mode, or when the endpoints are capable of full-duplex operation.

To improve on existing Physical Layer Security schemes and to minimize the case of key mismatch, e.g., when the perception of the wireless channel is different between the two endpoints, the present disclosure uses a variety of quantized input parameters for the key generation and a novel scheme with a training sequence and a Message Authentication Code for Integrity (“MAC-I”) for direct key verification. This novel scheme offers a direct verification whether the key generation on both endpoints was successful, i.e., the key generated from the channel information on both sides is identical. A various number of parameters were identified that could form the input to the key derivation function and a key verification procedure is described that needs to be performed until both sides have generated the same key.

Disclosed are solutions for physical layer secret key generation. The solutions may be implemented by apparatus, systems, methods, or computer program products. In some embodiments, secret key generation is disclosed where the randomness and uniqueness of the channel state information between two devices is utilized to generate a shared secret key. Thereby, the nodes achieve a shared secret key without communicating the key over the public channel.

In order to ensure the correctness of the shared secret keys at both devices, a verification mechanism based on MAC-I is disclosed that is continued until successful verification of the shared keys. Disclosed herein is a configuration process among the devices in order to adapt the secret key generation process to the various device capabilities and available resources.

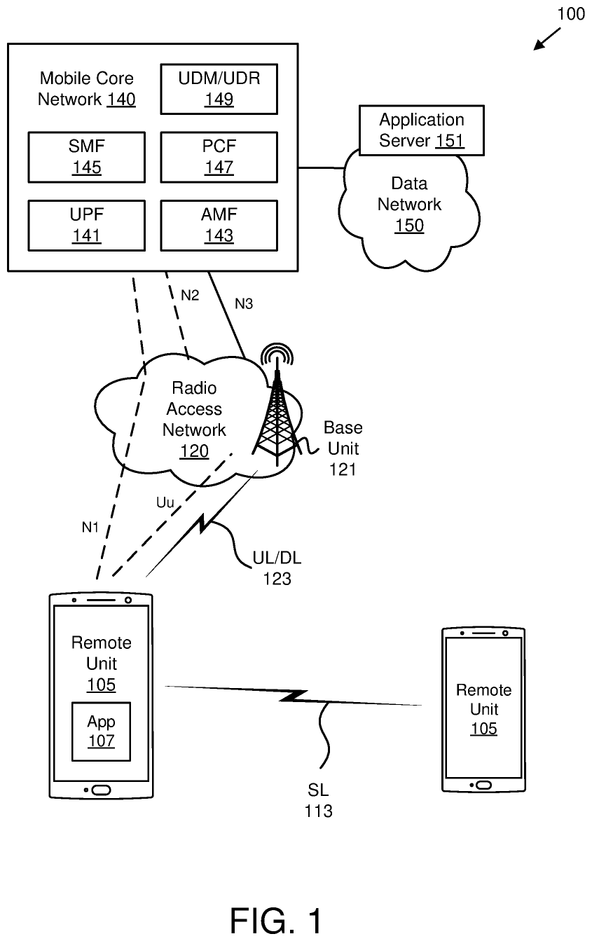

FIG. 1 depicts a wireless communication system 100 for physical layer secret key generation, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “CNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

While FIG. 1 depicts components of a 5G RAN and a 5G core network, the described embodiments for physical layer secret key generation apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), High Speed Packet Access (“HSPA”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, endpoint, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, endpoint, but it is replaceable by any other remote device, e.g., remote unit, MS, ME, etc. Further, the operations are described mainly in the context of 5G NR. However, the below described solutions/methods are also equally applicable to other mobile communication systems for physical layer secret key generation.

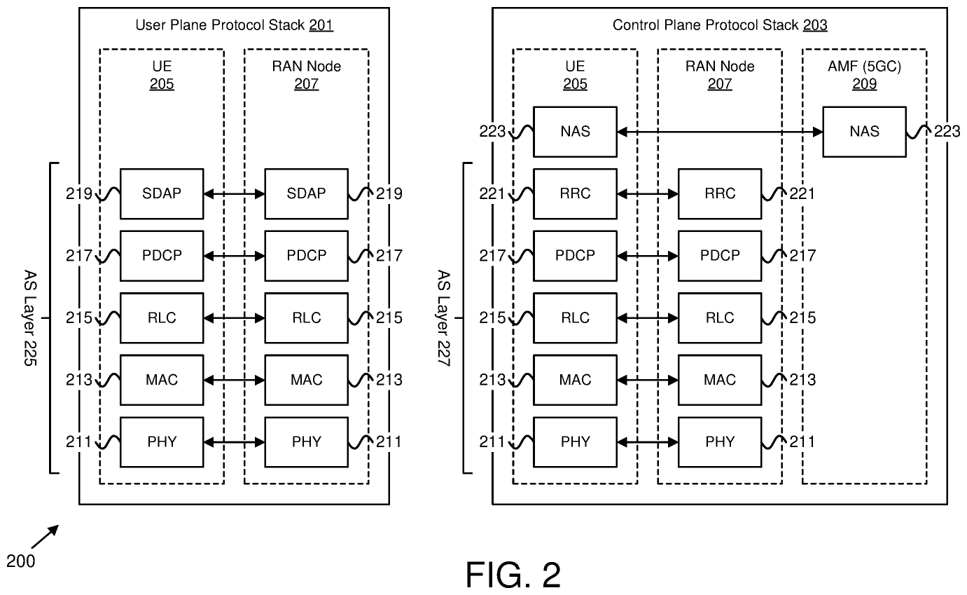

FIG. 2 depicts a protocol stack 200, according to embodiments of the disclosure. While FIG. 2 shows a UE 205, a RAN node 207 (e.g., a gNB) and a 5G core network 209 (containing, e.g., an AMF), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes the physical (“PHY”) layer 211, the Medium Access Control (“MAC”) sublayer 213, the Radio Link Control (“RLC”) sublayer 215, a Packet Data Convergence Protocol (“PDCP”) sublayer 217, and Service Data Adaptation Protocol (“SDAP”) layer 219. The Control Plane protocol stack 203 includes a PHY layer 211, a MAC sublayer 213, a RLC sublayer 215, and a PDCP sublayer 217. The Control Plane protocol stack 203 also includes a Radio Resource Control (“RRC”) layer 221 and a Non-Access Stratum (“NAS”) layer 223.

The AS layer 225 (also referred to as “AS protocol stack”) for the User Plane protocol stack 201 consists of at least the SDAP sublayer 219, PDCP sublayer 217, RLC sublayer 215 and the MAC sublayer 213, and the PHY layer 211. The AS layer 227 for the Control Plane protocol stack 203 consists of at least the RRC sublayer 221, PDCP sublayer 217, RLC sublayer 215, the MAC sublayer 213, and the PHY layer 211. The Layer-1 (“L1”) comprises the PHY layer 211. The Layer-2 (“L2”) is split into the SDAP sublayer 219, PDCP sublayer 217, RLC sublayer 215, and the MAC sublayer 213. The Layer-3 (“L3”) includes the RRC sublayer 221 and the NAS layer 223 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The PHY layer 211 offers transport channels to the MAC sublayer 213. The MAC sublayer 213 offers logical channels to the RLC sublayer 215. The RLC sublayer 215 offers RLC channels to the PDCP sublayer 217. The PDCP sublayer 217 offers radio bearers to the SDAP sublayer 219 and/or RRC layer 221. The SDAP sublayer 219 maps QOS flows within a PDU Session to a corresponding Data Radio Bearer over the air interface and the SDAP sublayer 219 interfaces the QoS flows to the 5GC (e.g., to user plane function, UPF). The RRC layer 221 provides for the addition, modification, and release of Carrier Aggregation (“CA”) and/or Dual Connectivity (“DC”). The RRC layer 221 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The NAS layer 223 is between the UE 205 and an AMF in the 5GC 209. NAS messages are passed transparently through the RAN. The NAS layer 223 is used to manage the establishment of communication sessions and for maintaining continuous communications with the UE 205 as it moves between different cells of the RAN. In contrast, the AS layers 225 and 227 are between the UE 205 and the RAN (i.e., RAN node 207) and carry information over the wireless portion of the network. While not depicted in FIG. 2, the IP layer exists above the NAS layer 223, a transport layer exists above the IP layer, and an application layer exists above the transport layer.

The MAC layer 213 is the lowest sublayer in the Layer-2 architecture of the NR protocol stack. Its connection to the PHY layer 211 below is through transport channels, and the connection to the RLC layer 215 above is through logical channels. The MAC layer 213 therefore performs multiplexing and demultiplexing between logical channels and transport channels: the MAC layer 213 in the transmitting side constructs MAC PDUs, known as transport blocks, from MAC Service Data Units (“SDUs”) received through logical channels, and the MAC layer 213 in the receiving side recovers MAC SDUs from MAC PDUs received through transport channels.

The MAC layer 213 provides a data transfer service for the RLC layer 215 through logical channels, which are either control logical channels which carry control data (e.g., RRC signaling) or traffic logical channels which carry user plane data. On the other hand, the data from the MAC layer 213 is exchanged with the PHY layer 211 through transport channels, which are classified as downlink or uplink. Data is multiplexed into transport channels depending on how it is transmitted over the air.

The PHY layer 211 is responsible for the actual transmission of data and control information via the air interface, i.e., the PHY Layer 211 carries all information from the MAC transport channels over the air interface on the transmission side. Some of the important functions performed by the PHY layer 211 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 221. The PHY layer 211 performs transmissions based on transmission parameters, such as the modulation scheme, the coding rate (i.e., the modulation and coding scheme (“MCS”)), the number of physical resource blocks etc.

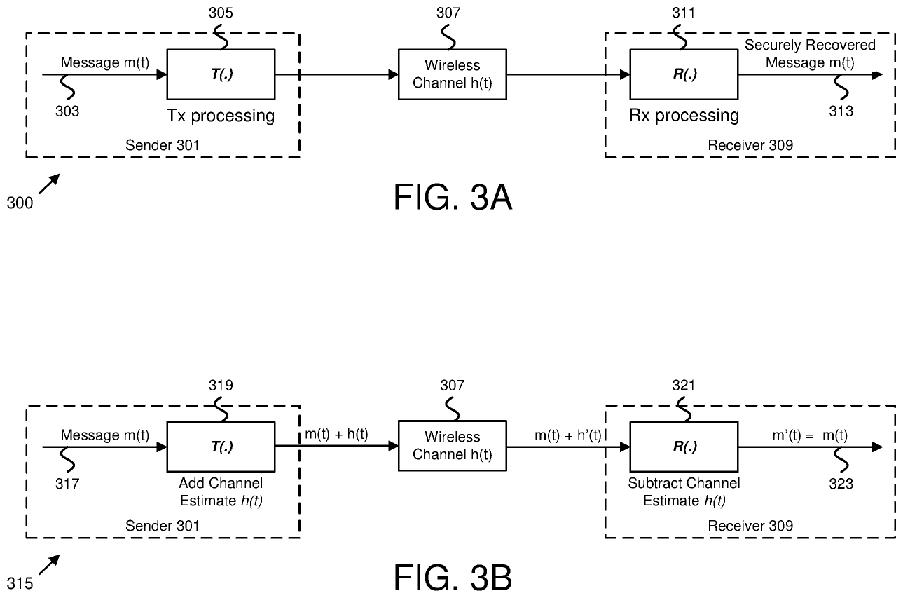

FIG. 3A depicts a general Physical Layer Scheme 300 for Secure Information Exchange, according to embodiments of the disclosure. The sender 301 transforms the message m(t) 303 using the transformation T(.) 305, which is then transmitted via the wireless channel 307 to the receiver 309. At the receiver 309, the transformation R(.) 311 is implemented to extract the transmitted transformed message 313. The pair of T(.), R(.) are chosen such that the message m(t) is recovered securely at the receiver 309, where an eavesdropping attack can be avoided. The design and implementation of the sender-side processing using the transformation T(.) 305 and the receiver-side processing using the transformation R(.) 311 are based on the modification or utilization of the physical layer characteristics of the system, e.g., channel state information.

FIG. 3B depicts a special case of the Physical Layer Scheme 315 for Secure Information Exchange, according to embodiments of the disclosure. Here, the message m(t) 317 is already modulated, and the Sender 301 simply adds the Channel Estimate h(t) to the signal (see block 319), which is then transmitted via the wireless channel 307 to the receiver 309, which is subtracting the Channel Estimate (see block 321) in order to restore the original message 323. In some embodiments, the Channel Estimate h(t) accounts for the randomness of the channel, e.g., with the parameters such as: Channel estimates, Received Signal Strength (“RSS”), Distance and Angle of Arrival (“AoA”).

Additionally, different approaches on physical layer security in may utilize one of three different categories:
Channel Approaches (i.e., including Radio Frequency (“RF”) fingerprinting, Algebraic channel decomposition multiplexing (“ACDM”) precoding, and/or Randomization of Multiple-In, Multiple-Out (“MIMO”) transmission coefficients)
Code Approaches (i.e., including Error correction coding and/or Spread spectrum coding)
Power and Signal Approaches (i.e., including Directional antennas and beamforming and/or Injection of artificial noise and friendly jamming)

The solutions described below are of the category “code approach.” Note that the below embodiments are not restricted to a specific radio technology, and thus may be implemented using Bluetooth, ZigBee, 802.11 WLAN variants, 3GPP radio (like GSM, GPRS, UMTS, HSPA, LTE, 5G NR), etc. The device for sending and receiving is therefore neutrally called endpoint, so it could be a UE (user equipment), MS (mobile station), any other device with a wireless transceiver, e.g., a laptop, tablet, vehicle, etc. Additionally, an endpoint may be a network-side node with a wireless transceiver, such as an AP (access point), BS (base station), or any other device forming part of a radio access network.

Key generation using physical layer characteristics is performed first in the sender side, then in the receiver side. The endpoints may use a variety of quantized input parameters for the key generation. To ensure the correctness of the generated key, the endpoints exchange messages comprising a known/preconfigured Training Sequence protected by a Message Authentication Code for Integrity (“MAC-I”).

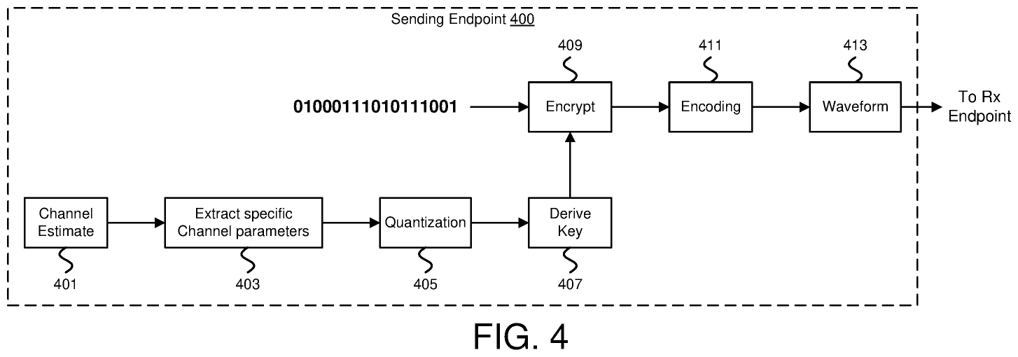

FIG. 4 depicts the high-level functionality for the sending endpoint 400, according to embodiments of the disclosure. Here, the sending endpoint 400 performs channel estimation 401 towards the communication endpoint (i.e., the receiving endpoint) and extracts the relevant channel parameters 403, e.g. Received Signal Strength (“RSS”), Channel State Information (“CSI”), Signal-to-Noise Ratio (“SNR”), Carrier-to-Interference Ratio (“CIR”), Distance or Angle of Arrival (“AoA”), Power Delay Profile (“PDP”), Doppler Delay Profile (“DDP”), Signal-to-Interference Ratio (“SIR”), Signal-to-Interference plus Noise Ratio (“SINR”) Assigned propagation condition (e.g., line-of-sight (“LOS”) and/or non-line-of-sight (“NLOS”)), calculated path loss, Angle of Departure (“AoD”), Time of Arrival (“ToA”), Delay Spread, Angular spread, Spread of Arrival, Spread of Shadow fading and Spread of Departure. Those parameters are available in an analogue measurement and require quantization 405 as well.

The sending endpoint 400 then derives the secret key (see block 407) using the selected quantized parameters as input to the Key Derivation Function (“KDF”). It is assumed that quantization thresholds and number of levels are chosen such that together with a proper key generating function the sender and the receiver endpoints generate the same key values.

There may be additional input to the KDF which is pre-shared or generated during the communication, e.g., a static training sequence, a sequence number counting up the connection attempts, etc. The KDF may be a hash function (e.g., a Secure Hash Algorithm (“SHA”), such as SHA256) or a keyed hash function if a pre-shared input is used as a key (e.g., a Keyed-Hash Message Authentication Code (“HMAC”), such as HMAC-SHA-256). The output length (i.e., key length) depends on the used algorithm. It is necessary that the same KDF is used in both endpoints in order to ensure that the same key is generated.

The String S may be constructed from the selected quantized n+1 input parameters Px and their corresponding lengths Lx as follows:

$$S = P 0 ‖ L 0 ‖ P 1 ‖ L 1 ‖ P 2 ‖ L 2 ‖ P 3 ‖ L 3 ‖ … ‖ Pn ‖ Ln$$

The final output, i.e., the derived key K_{d} is equal to the KDF computed on the string S. For example, K_{d}=SHA-256 (S).

In case a pre-shared training sequence or other static parameter common to both endpoints is used as an input key Ki, the final output, i.e., the derived key K_{d} is equal to the KDF computed on the string S using the input key:

$${K}_{d} = HMAC - SHA - 256 ( {K}_{i} , S )$$

The derived key K_{d} is then used to cipher the message (depicted as input string “01000111010111001”) that should be sent (see block 409). Due to the high data rate at this layer, the use of a block-cipher, e.g., like Advanced Encryption Standard (“AES”), SNOW (a word-based synchronous stream cipher) or ZUC (a stream cipher) may enhance performance. The encrypted message is then encoded (see block 411), and modulated (see block 413), and sent to the receiving endpoint. Note here that the sending endpoint 400 and the receiving endpoint have a shared understanding of which channel parameters to use for key derivation, so that the same key is (separately) derived at both the sending endpoint 400 and the receiving endpoint.

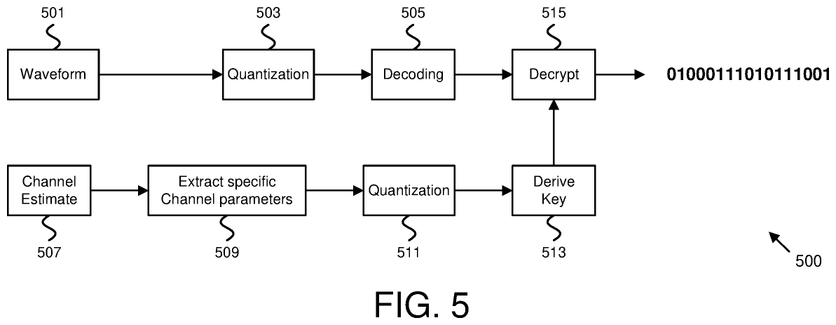

FIG. 5 depicts the high-level functionality for the receiving endpoint 500, according to embodiments of the disclosure. Here, a waveform is received (see block 501) and the received waveform is quantized (see block 503) and decoded (see block 505) so that the resulting bits can be decrypted with the corresponding algorithm and key. To obtain the key, the receiving endpoint 500 performs a channel estimation (see block 507), extracts specific channel parameter (see block 509), and quantizes the extracted parameters (see block 511) as described above with reference to FIG. 4. The receiving endpoint 500 uses the estimated parameters as the input for the key derivation (see block 513) in a similar way as described by the sender in order to compute the key K_{d}. The key K_{d} is then used to decrypt the message (see block 515). Note here that the sending endpoint and the receiving endpoint 500 have a shared understanding of which channel parameters to use for key derivation, so that the same key is (separately) derived at both the sending endpoint and the receiving endpoint 500. After the deciphering, the resulting bits can be processed further, e.g., with Forward Error Correction (“FEC”), etc. Here, the securely recovered message comprises the string “01000111010111001”.

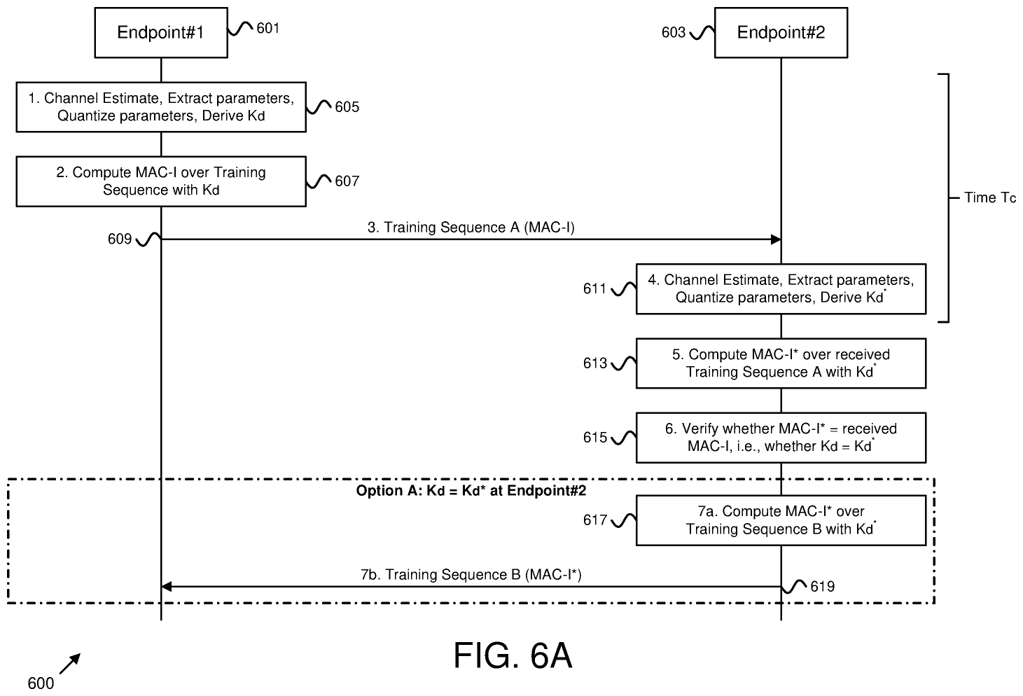

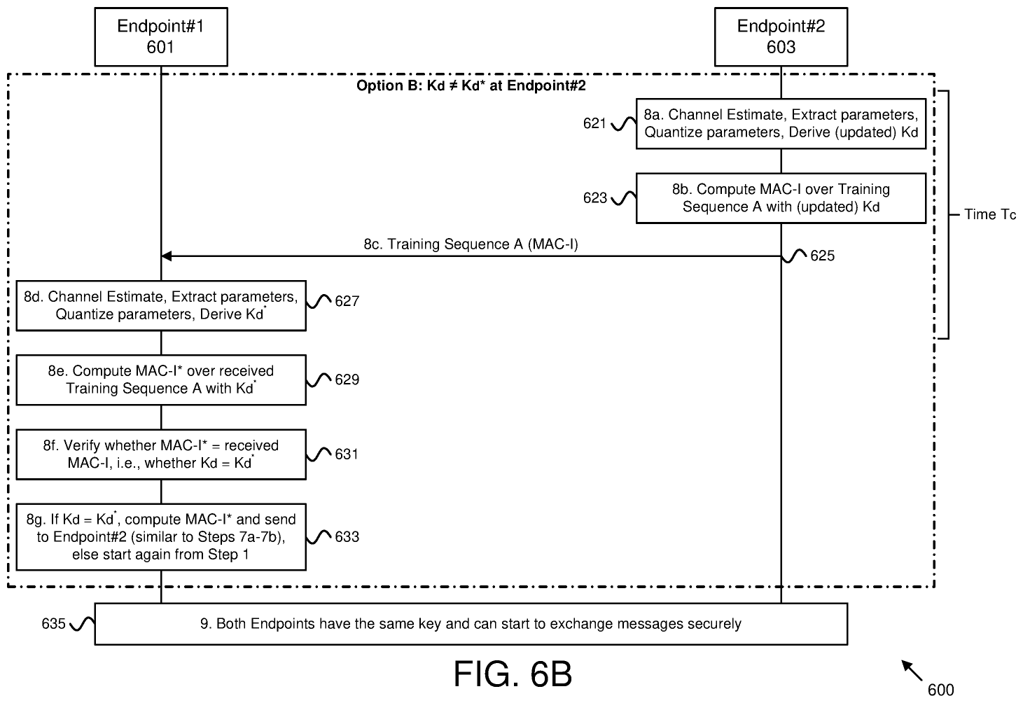

FIGS. 6A-6B depict a key verification procedure 600, according to embodiments of the disclosure. The key verification procedure 600 involves a first endpoint 601 (denoted Endpoint #1) and a second endpoint 603 (denoted Endpoint #2). In order to assure that the keys on both side match, the two endpoints need to exchange a Trainings Sequence, integrity protected with the new key. Note that the Endpoint #1 601 may be an embodiment of the remote unit 105 and/or the UE 205. Alternatively, the Endpoint #1 601 may be an embodiment of the base unit 121 and/or the RAN node 207. Similarly, the Endpoint #2 603 may be embodiment of the remote unit 105 and/or the UE 205. Alternatively, the Endpoint #2 603 may be an embodiment of the base unit 121 and/or the RAN node 207.

Beginning on FIG. 6A, the key verification procedure 600 starts at Step 1 as the Endpoint #1 601 performs a channel estimate and selects the parameters according to above description and quantizes the values and derives the key K_{d} (see block 605).

At Step 2, the Endpoint #1 601 selects a Training Sequence A, which is known (e.g., preconfigured) to both the sending and receiving endpoints and is proven also to help the receiving endpoint to perform a precise channel estimate. To protect the Training Sequence A, the Endpoint #1 601 computes a (first) MAC-I over the Training Sequence A using the key K_{d} (see block 607). The Endpoint #1 601 may use of a specific integrity algorithm (e.g., AES, ZUC, SNOW, etc.) or may simply form an input string S to a KDF by the following parameters:
P0: Trainings Sequence
L0: Length of Trainings Sequence
The input key to the KDF is the key K_{d}

The (first) MAC-I is identified with the 128 least significant bits of the output of the KDF. If a longer MAC-I is desired, the truncation point can be floated to that specific value, e.g., 256 bits, but it must be always the same in both endpoints.

In some embodiments, in order to provide replay protection, the Endpoint #1 601 may start a counter for each message it sends with a Training Sequence and may include the Counter and the Length of the Counter also in the input string S.

At Step 3, the Endpoint #1 601 sends the Trainings Sequence with the MAC-I to the Endpoint #2 603 (see messaging 609).

At Step 4, upon reception of the message with the Trainings Sequence A, the Endpoint #2 603 performs a channel estimate and selects the parameters according to above description and quantizes the values and derives the key K_{d}* (see block 611). The channel estimates of Endpoint #1 601 and Endpoint #2 603 have a time offset of the Time T_{c} and it is recommended for varying channels to keep T_{c} as low as possible, else the quantized channel parameters may differ on both endpoints and thus result in a key mismatch.

At Step 5, the Endpoint #2 603 computes the (first) MAC-I* with K_{d}* in the similar way as done by the Endpoint #1 601 in Step 2 (see block 613).

At Step 6, the Endpoint #2 603 verifies whether the computed MAC-I* is identical with the received MAC-I, i.e., whether the derived key K_{d}* is equal to K_{d} (see block 615). Note in case of large time T_{c}, it may happen that the channel changed so much that the parameters lead to a key mismatch.

Two options are possible: Option A (comprising steps 7) where the Endpoint #2 603 acknowledges the key verification: or Option B (comprising steps 8) where the Endpoint #2 603 restarts the keying procedure. Option A is triggered when key verification is successful at the Endpoint #2 603. Option B is triggered when key verification fails at the Endpoint #2 603.

At Step 7a (Option A), the Endpoint #2 603 selects a Training Sequence B (i.e., different than Training Sequence A) and computes the (second) MAC-I* over the selected Training Sequence using the key K_{d}*=K_{d} (see block 617). Note that the Training Sequence B is also known (e.g., preconfigured) to both the sending and receiving endpoints. Alternatively, instead of using a different Training Sequence, the Endpoint #2 603 could also simply encrypt Training Sequence A with the key K_{d}*=K_{d} and compute the (second) MAC-I* over the encrypted Training Sequence using the key K_{d}*=K_{d}.

At Step 7b (Option A), the Endpoint #2 603 sends the Trainings Sequence B with the (second) MAC-I* to the Endpoint #1 601 (see messaging 619). Alternatively, the Endpoint #2 603 sends the Trainings Sequence B with the (second) MAC-I* to the Endpoint #1 601. The Endpoint #1 601 knows now that the security key is verified, and that Endpoint #2 603 can decrypt and encrypt messages with the key K_{d}*=K_{d}.

Continuing on FIG. 6B, at Step 8a (Option B), in case of a key mismatch, the Endpoint #2 603 just restarts the procedure, e.g., performs a channel estimate, selects the parameters according to above descriptions, quantizes the values, and derives an updated key K_{d} (see block 621).

At Step 8b (Option B), the Endpoint #2 603 selects the Training Sequence A and, to protect the Training Sequence A, the Endpoint #1 601 computes a (second) Message Authentication Code for Integrity (“MAC-I”) over the Training Sequence A using the updated key K_{d} (see block 623), i.e., in the similar way as done by the Endpoint #1 601 in Step 2.

At Step 8c (Option B), the Endpoint #2 603 sends the Trainings Sequence with the (second) MAC-I to the Endpoint #1 601 (see messaging 625).

At Step 8d (Option B), the Endpoint #1 601 now detects that there is a key mismatch since it receives the Trainings Sequence A protected with a new MAC-I. The Endpoint #1 601 performs a channel estimate, selects the parameters according to above descriptions, and quantizes the values and derives the new key K_{d}* (see block 627). The channel estimates of the Endpoint #1 601 and the Endpoint #2 603 have a time offset of the Time T_{c} and it is recommended for varying channels to keep T_{c} as low as possible, else the quantize parameters may differ on both endpoints and thus result in a key mismatch.

At Step 8e (Option B), the Endpoint #1 601 computes the new (third) MAC-I* with the new K_{d}* in the similar way as Endpoint #2 603 in step 8b (see block 629). Note that the Endpoint #1 601 behavior in Step 8e is analogous to the Endpoint #2 603 behavior in Step 5.

At Step 8f (Option B), the Endpoint #1 601 verifies whether the new MAC-I* is identical with the received MAC-I, i.e., whether the new key K_{d}* is equal to the updated K_{d} (see block 631). Note in case of large times T_{c}, it may happen that the channel changed so much that the parameters lead to a key mismatch.

At Step 8g (Option B), if the keys are equal, then the Endpoint #1 601 sends an acknowledgement to the Endpoint #2 603, i.e., either a Training Sequence B with a (fourth) MAC-I* or the encrypted Trainings Sequence A (see block 633). Otherwise, if there is a key mismatch, then the procedure starts again with step 1 and the Endpoint #1 601 performs a new channel estimate. The Trainings Sequence messages (and corresponding MAC-I) are exchanged until the key is the same on both sides or until the counter reaches a maximum threshold value (i.e., to prevent an endless loop of message exchange).

At Step 9, both endpoints have indicated successful key establishment (see block 635). At this point in time the real data transmission can be performed in a protected way.

In order to minimize the round trips of Training Sequence messages it is recommended to use a sensitive quantization of the parameters. Note that there could be a key guessing attack in case quantization with too few levels is used and the parameter combinations are limited. Further in highly time varying channels, the variation of a parameter within the time T_{c} should be within the quantization range of one level in order not to lead to a key mismatch.

In some embodiments of the above method, the end points may implement the scheme in FDD mode, relying on the correlated channel condition at different frequencies. In this case, the frequency and timing configuration of the CSI estimation phase will be adjusted to support the FDD case.

In some embodiments, the end points may use the same communication resource in both directions, when the endpoints are facilitated with the Full-Duplex (“FD”) capability. In this case, the CSI estimation is done over the same channel, which better maintains the reciprocity. Nevertheless, the CSI estimation will be done after implementing the self-interference cancellation procedures.

In some embodiments, in order to resolve the scenarios where Option B holds, i.e., the generated keys do not match, the Error Correction Codes (“FEC”) codes are communicated. In some implementations, the FEC codes are generated from the generated keys and communicated to the other end device. In some implementations, the exchange of the FEC codes can be done incrementally, i.e., in smaller steps until key agreement is achieved. In some implementations, the FEC codes can be calculated from the generated key, or directly from the quantized channel values or some combination thereof.

In some embodiments, the generation of the key from the quantized estimated values can rely on the history of the CSI estimations. In this case, when the key agreement is not reached, the newly estimated and quantized CSI values are augmented with the previous values to form a longer sequence. An updated key generation function (taking into account the nature of the augmented sequence) can be then used to generate the new key. In some implementations, a FEC code can be calculated and exchanged from the augmented quantized sequence.

In some embodiments, the nodes may use prior knowledge of the channel statistics via, e.g., prior communication phases with co-located devices, and/or the device capability, as well as the available/scheduled resources in order to configure the CSI estimation and the Key generation procedure. In some implementations, devices may exchange and agree on a configuration, e.g., of the structure:

```
Key_generation_CSI_estimation_confg. = {
  Idx_mode: [identifying the mode of CSI training, including, e.g., FD, FDD, TDD]
  Channel_Frequency_confg. [the utilized frequency resource for CSI estimation],
  Channel_time_confg. [the utilized time resource for CSI estimation, including periodicity
  and duration of the training sequences],
  Channel_measurement_types: [e.g., CSI, RSS, SNR, CIR, or a combination thereof],
  Quantization_resolution: [number of bits for quantization of each parameter]
  Idx_KDF: [an index identifying the KDF to be used]
  Idx_TrainingSeq: [an index identifying a channel training sequence to be used]
  Idx_FEC_type: [an index identifying the type and length of an error correction code to be
  used in case of a key mismatch]
  }
```

In some implementation, the smaller communicated feature value among the nodes, representing the smaller available capability or resource among the endpoints may be chosen for the purpose of the communication. In some implementations, the nodes exchange information to agree on a specific configuration parameter. In some implementations, a device (endpoint) with a higher awareness or capability can make the decision on the configuration parameters and communicate it to the other device.

In an example implementation, in the presence of imperfect reciprocity, e.g., due to imperfect transmit/receive antenna calibration or channel fluctuations in the frequency domain, the nodes may adopt a configuration in the TDD or FD modes or an FDD mode with a small bandwidth. In the same example, the nodes may utilize a longer training time, coarser quantization levels, a larger error correction code overhead or a combination thereof to address the impact of imperfect reciprocity.

In some implementations, the nodes may be pre-configured with a table connecting the value of the configuration ‘Key_generation_CSI_estimation_confg’ to the estimated channel statistics and/or the quality of the channel reciprocity. In an embodiment, an index, identifying the values in the configuration ‘Key_generation_CSI_estimation_confg’ will be communicated among the nodes, following a pre-configured table. Table 1 exemplifies such a table, where a lower index corresponds to a less accurate reciprocity and device capability.

TABLE 1
Illustration of an example resource configuration table

| | Param. | | | | | |
|---|---|---|---|---|---|---|
| | | Frequency | Time | Ch. Measurement | Quantization | FEC |
| Idx. | Mode | Resource | Resource | types | Resolution | Overhead |
| 0 | TDD | 10 PRB | 30 Sym. | RSS, | 2 bit | 50% |
| 1 | TDD | 10 PRB | 10 Sym. | CSI + RSS, | 3 bits | 20% |
| 2 | FD | 5 PRB | 5 Sym. | CSI + RSS + | 4 bits | 20% |
| | | | | SNR + CIR | | |
| . . . | | | | | | |

In some implementations, each index value identifies the exact or a range of values for the parameters defined in the configuration ‘Key_generation_CSI_estimation_confg’. In some implementations, a node may send multiple indices to identify the suggested range of the configuration values for a node. In some implementations, the indicated index set is accompanied with an indication of preference/priority among the indicated index set.

In some embodiments, the devices (endpoint) may perform a public (not secured) communication in an initial phase. This will be the case when there are some content available which does not need to be protected. In this case, the decoded data sequence can be later used to estimate a CSI value history. The CSI value history can be then used to generate keys with a higher accuracy. In some implementations, the CSI training sequence as well as the previously decoded data sequence can be jointly used to calculate the key.

In some implementations, a part of the initial configuration may be done with the help of a third node where the third node has some prior knowledge of the CSI state.

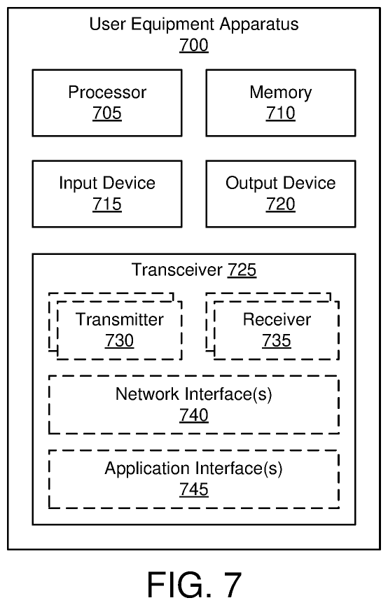

FIG. 7 depicts a user equipment apparatus 700 that may be used for physical layer secret key generation, according to embodiments of the disclosure. In various embodiments, the user equipment apparatus 700 is used to implement one or more of the solutions described above. The user equipment apparatus 700 may be one embodiment of a UE endpoint, such as the remote unit 105 and/or the UE 205, as described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the user equipment apparatus 700 to implement the above described UE behaviors. In certain embodiments, the processor 705 may include an application processor (also known as “main processor”) which manages application-domain and operating system (“OS”) functions and a baseband processor (also known as “baseband radio processor”) which manages radio functions.

In various embodiments, the user equipment apparatus 700 is a first endpoint according to the above described solutions. In such embodiments, the processor 705 generates a security key (e.g., K_{d}) using channel information of the wireless channel and computes a first authentication code (e.g., a MAC-I) over a first Training Sequence (e.g., Sequence A) using the security key. In certain embodiments, via the transceiver 725, the processor 705 performs channel estimation (e.g., channel measurements) of the wireless channel and extracts channel parameters from the channel estimation. Moreover, the processor 705 quantizes the extracted channel parameters to obtain the channel information. In such embodiments, to generate the security key, the processor 705 inputs a plurality of quantized channel parameters to a key derivation function.

Via the transceiver 725, the processor 705 sends the first Training Sequence including the first authentication code to a second endpoint and receives a response message from the second endpoint. Here, the response message including a second authentication code (e.g., a MAC-I). The processor 705 validates the second authentication code and indicates successful key establishment in response to successful validation of the second authentication code.

In some embodiments, the response message includes a second Training Sequence (e.g., Sequence B) different than the first Training Sequence, where the response message indicates successful key verification by the second endpoint. In certain embodiments, to validate the second authentication code, the processor 705 computes a third authentication code (e.g., a MAC-I) over the second Training Sequence, i.e., using the previously generated security key (e.g., K_{d}). The processor 705 compares the computed third authentication code with the second authentication code received from the second endpoint and indicates successful key establishment when the third authentication code is equal to the second authentication code.

In some embodiments, the response message includes the first Training Sequence (e.g., Sequence A) encrypted using the security key, where the response message indicates successful key verification by the second endpoint. In certain embodiments, to validate the second authentication code, the processor 705 computes a third authentication code (e.g., a MAC-I) over the encrypted first Training Sequence, i.e., using the previously generated security key (e.g., K_{d}). The processor 705 compares the computed third authentication code with the second authentication code received from the second endpoint and indicates successful key establishment when the third authentication code is equal to the second authentication code.

In some embodiments, the response message indicates key verification failure by the second endpoint and the response message includes the first Training Sequence (e.g., Sequence A). In such embodiments, via the transceiver 725, the processor 705 determines updated channel information of the wireless channel and generates a second security key (e.g., K_{d}*) using the updated channel information of the wireless channel. The processor 750 computes a third authentication code (e.g., a MAC-I) over the first Training Sequence using the second security key and compares the computed third authentication code with the second authentication code received from the second endpoint. The processor 705 indicates successful key establishment when the third authentication code is equal to the second authentication code.

In certain embodiments, to indicate successful key establishment, the processor 705 computes a fourth authentication code (e.g., a MAC-I) over a second Training Sequence (e.g., Sequence B) using the second security key, the second Training Sequence being different than the first Training Sequence. Via the transceiver 725, the processor 705 sends the second Training Sequence including the fourth authentication code to the second endpoint, where the second Training Sequence indicates successful key verification by the first endpoint.

In various embodiments, the user equipment apparatus 700 is a second endpoint according to the above described solutions. In such embodiments, the transceiver 725 receives a first Training Sequence including a first authentication code (e.g., a MAC-I) from a first endpoint and the processor 705 generate a security key (e.g., K_{d}*) using channel information of the wireless channel. In some embodiments, via the transceiver 725, the processor 705 performs channel estimation (e.g., measurements) of the wireless channel and extracts channel parameters from the channel estimation. Moreover, the processor 705 quantizes the extracted channel parameters to obtain the channel information. In such embodiments, to generate the security key, the processor 705 inputs a plurality of quantized channel parameters to a key derivation function.

The processor 705 validates the first authentication code using the generated security key and indicates successful key establishment in response to successful validation of the first authentication code. In some embodiments, to validate the first authentication code (e.g., a MAC-I), the processor 705 computes a third authentication code (e.g., a MAC-I) over the second Training Sequence, using the previously generated security key (e.g., K_{d}*) and compares the computed third authentication code (e.g., a MAC-I) with the second authentication code received from the second endpoint. The processor 705 indicates successful key establishment when the third authentication code (e.g., a MAC-I) is equal to the second authentication code (e.g., a MAC-I).

The processor 705 computes a second authentication code (e.g., a MAC-I) over a second Training Sequence and sends a response message to the first endpoint, the response message including the second authentication code.

In certain embodiments, the response message includes a second Training Sequence (e.g., Sequence B) different than the first Training Sequence, where the response message indicates successful key verification by the second endpoint. In certain embodiments, the response message includes the first Training Sequence (e.g., Sequence A) encrypted using the security key (e.g., K_{d}*), where the response message indicates successful key verification by the second endpoint.

In some embodiments, the response message indicates key verification failure by the second endpoint. In such embodiments, the processor 705 further determines updated channel information of the wireless channel in response to unsuccessful validation of the first authentication code. The processor 750 generates a second security key (e.g., K_{d}*) using the updated channel information of the wireless channel and computes the second authentication code over the first Training Sequence (e.g., Sequence A) using the second security key. Here, the wherein the response message includes the first Training Sequence.

In certain embodiments, the transceiver 725 receives a second response message from the first endpoint, where the second response message including a third authentication code (e.g., a MAC-I), and the processor 705 validates the third authentication code. The processor 705 indicates successful key establishment in response to successful validation of the third authentication code.

In certain embodiments, to validate the third authentication code, the processor 705 computes a fourth authentication code (e.g., a MAC-I) over a second Training Sequence, i.e., using the second security key (e.g., K_{d}), and compares the computed fourth authentication code with the third authentication code received from the first endpoint. The processor 705 indicates successful key establishment when the third authentication code is equal to the fourth authentication code.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to physical layer secret key generation. For example, the memory 710 may store various parameters, panel/beam configurations, resource assignments, policies, and the like as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

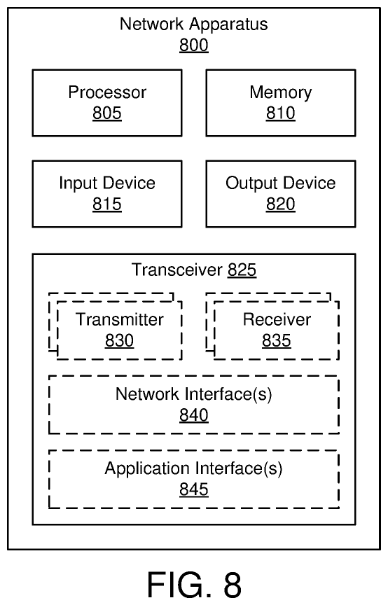

FIG. 8 depicts a network apparatus 800 that may be used for physical layer secret key generation, according to embodiments of the disclosure. In one embodiment, network apparatus 800 may be one implementation of a network endpoint, such as the base unit 121 and/or RAN node 207, as described above. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above described RAN behaviors. In some embodiments, the network apparatus 800 may configure one or more endpoint devices with the Training Sequences to be used in the key verification procedure. When operating as a RAN node, the processor 805 may include an application processor (also known as “main processor”) which manages application-domain and operating system (“OS”) functions and a baseband processor (also known as “baseband radio processor”) which manages radio functions.

In various embodiments, the network apparatus 800 is a first endpoint according to the above described solutions. In such embodiments, the processor 805 generates a security key (e.g., K_{d}) using channel information of the wireless channel and computes a first authentication code (e.g., a MAC-I) over a first Training Sequence (e.g., Sequence A) using the security key. In certain embodiments, via the transceiver 825, the processor 805 performs channel estimation (e.g., channel measurements) of the wireless channel and extracts channel parameters from the channel estimation. Moreover, the processor 805 quantizes the extracted channel parameters to obtain the channel information. In such embodiments, to generate the security key, the processor 805 inputs a plurality of quantized channel parameters to a key derivation function.

Via the transceiver 825, the processor 805 sends the first Training Sequence including the first authentication code to a second endpoint and receives a response message from the second endpoint. Here, the response message including a second authentication code (e.g., a MAC-I). The processor 805 validates the second authentication code and indicates successful key establishment in response to successful validation of the second authentication code.

In some embodiments, the response message includes a second Training Sequence (e.g., Sequence B) different than the first Training Sequence, where the response message indicates successful key verification by the second endpoint. In certain embodiments, to validate the second authentication code, the processor 805 computes a third authentication code (e.g., a MAC-I) over the second Training Sequence, i.e., using the previously generated security key (e.g., K_{d}). The processor 805 compares the computed third authentication code with the second authentication code received from the second endpoint and indicates successful key establishment when the third authentication code is equal to the second authentication code.

In some embodiments, the response message includes the first Training Sequence (e.g., Sequence A) encrypted using the security key, where the response message indicates successful key verification by the second endpoint. In certain embodiments, to validate the second authentication code, the processor 805 computes a third authentication code (e.g., a MAC-I) over the encrypted first Training Sequence, i.e., using the previously generated security key (e.g., K_{d}).

The processor 805 compares the computed third authentication code with the second authentication code received from the second endpoint and indicates successful key establishment when the third authentication code is equal to the second authentication code.

In some embodiments, the response message indicates key verification failure by the second endpoint and the response message includes the first Training Sequence (e.g., Sequence A). In such embodiments, via the transceiver 825, the processor 805 determines updated channel information of the wireless channel and generates a second security key (e.g., K_{d}*) using the updated channel information of the wireless channel. The processor 850 computes a third authentication code (e.g., a MAC-I) over the first Training Sequence using the second security key and compares the computed third authentication code with the second authentication code received from the second endpoint. The processor 805 indicates successful key establishment when the third authentication code is equal to the second authentication code.

In certain embodiments, to indicate successful key establishment, the processor 805 computes a fourth authentication code (e.g., a MAC-I) over a second Training Sequence (e.g., Sequence B) using the second security key, the second Training Sequence being different than the first Training Sequence. Via the transceiver 825, the processor 805 sends the second Training Sequence including the fourth authentication code to the second endpoint, where the second Training Sequence indicates successful key verification by the first endpoint.

In various embodiments, the network apparatus 800 is a second endpoint according to the above described solutions. In such embodiments, the transceiver 825 receives a first Training Sequence including a first authentication code (e.g., a MAC-I) from a first endpoint and the processor 805 generate a security key (e.g., K_{d}*) using channel information of the wireless channel. In some embodiments, via the transceiver 825, the processor 805 performs channel estimation (e.g., measurements) of the wireless channel and extracts channel parameters from the channel estimation. Moreover, the processor 805 quantizes the extracted channel parameters to obtain the channel information. In such embodiments, to generate the security key, the processor 805 inputs a plurality of quantized channel parameters to a key derivation function.

The processor 805 validates the first authentication code using the generated security key and indicates successful key establishment in response to successful validation of the first authentication code. In some embodiments, to validate the first authentication code (e.g., a MAC-I), the processor 805 computes a third authentication code (e.g., a MAC-I) over the second Training Sequence, using the previously generated security key (e.g., K_{d}*) and compares the computed third authentication code (e.g., a MAC-I) with the second authentication code received from the second endpoint. The processor 805 indicates successful key establishment when the third authentication code (e.g., a MAC-I) is equal to the second authentication code (e.g., a MAC-I).

The processor 805 computes a second authentication code (e.g., a MAC-I) over a second Training Sequence and sends a response message to the first endpoint, the response message including the second authentication code.

In certain embodiments, the response message includes a second Training Sequence (e.g., Sequence B) different than the first Training Sequence, where the response message indicates successful key verification by the second endpoint. In certain embodiments, the response message includes the first Training Sequence (e.g., Sequence A) encrypted using the security key (e.g., K_{d}*), where the response message indicates successful key verification by the second endpoint.

In some embodiments, the response message indicates key verification failure by the second endpoint. In such embodiments, the processor 805 further determines updated channel information of the wireless channel in response to unsuccessful validation of the first authentication code. The processor 850 generates a second security key (e.g., K_{d}*) using the updated channel information of the wireless channel and computes the second authentication code over the first Training Sequence (e.g., Sequence A) using the second security key. Here, the wherein the response message includes the first Training Sequence.

In certain embodiments, the transceiver 825 receives a second response message from the first endpoint, where the second response message including a third authentication code (e.g., a MAC-I), and the processor 805 validates the third authentication code. The processor 805 indicates successful key establishment in response to successful validation of the third authentication code.

In certain embodiments, to validate the third authentication code, the processor 805 computes a fourth authentication code (e.g., a MAC-I) over a second Training Sequence, i.e., using the second security key (e.g., K_{d}), and compares the computed fourth authentication code with the third authentication code received from the first endpoint. The processor 805 indicates successful key establishment when the third authentication code is equal to the fourth authentication code.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to physical layer secret key generation. For example, the memory 810 may store parameters, configurations, resource assignments, policies, and the like, as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the Public Land Mobile Network (“PLMN”) and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

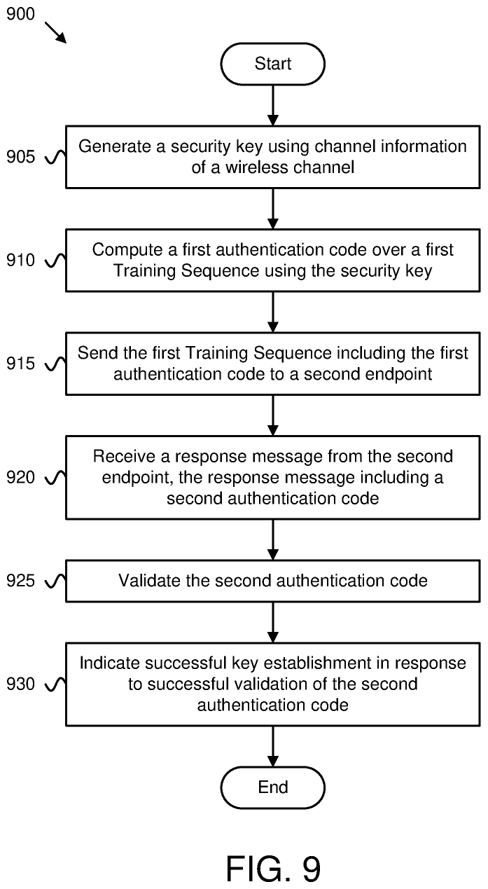

FIG. 9 depicts one embodiment of a method 900 for physical layer secret key generation, according to embodiments of the disclosure. In various embodiments, the method 900 is performed by a first endpoint, such as a remote unit 105, the base unit 121, the UE 205, the RAN node 207, the user equipment apparatus 700, the network apparatus 800, and/or another wireless endpoint device, as described above. In some embodiments, the method 900 is performed by a processor, such as a microcontroller, a microprocessor, a CPU, a GPU, an auxiliary processing unit, a FPGA, or the like.

The method 900 begins and generates 905 a security key (e.g., K_{d}) using channel information of a wireless channel. The method 900 includes computing 910 a first authentication code (e.g., a MAC-I) over a first Training Sequence (e.g., Sequence A) using the security key. The method 900 includes sending 915 the first Training Sequence including the first authentication code to a second endpoint. The method 900 includes receiving 920 a response message from the second endpoint, the response message including a second authentication code (e.g., a MAC-I). The method 900 includes validating 925 the second authentication code. The method 900 includes indicating 930 successful key establishment in response to successful validation of the second authentication code. The method 900 ends.

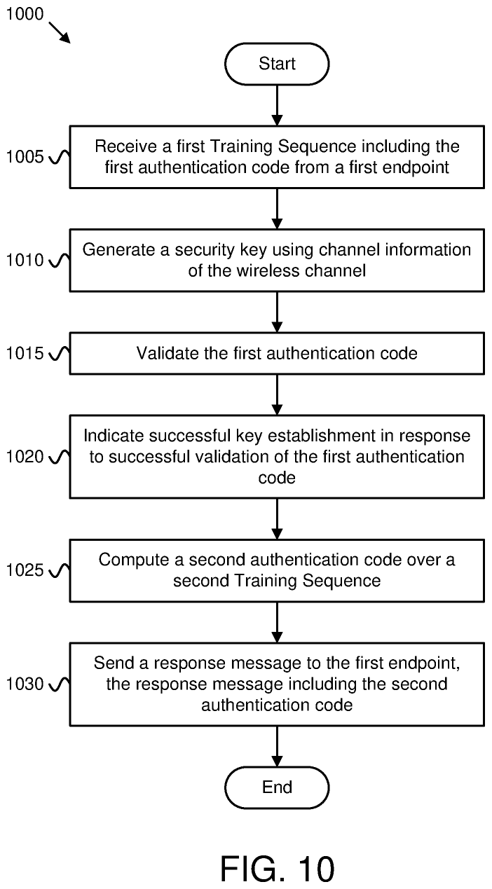

FIG. 10 depicts one embodiment of a method 1000 for physical layer secret key generation, according to embodiments of the disclosure. In various embodiments, the method 1000 is performed by a second endpoint, such as a remote unit 105, the base unit 121, the UE 205, the RAN node 207, the user equipment apparatus 700, the network apparatus 800, and/or another wireless endpoint device, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a first Training Sequence including a first authentication code (e.g., a MAC-I) from the first endpoint. The method 1000 includes generating 1010 a security key (e.g., K_{d}*) using channel information of the wireless channel. The method 1000 includes validating 1015 the first authentication code using the generated security key. The method 1000 includes indicating 1020 successful key establishment in response to successful validation of the first authentication code. The method 1000 includes computing 1025 a second authentication code (e.g., a MAC-I) over a second Training Sequence. The method 1000 includes sending 1030 a response message to the first endpoint, the response message including the second authentication code. The method 1000 ends.

Disclosed herein is a first apparatus for physical layer secret key generation, according to embodiments of the disclosure. The first apparatus may be implemented by a first endpoint, such as a remote unit 105, the base unit 121, the UE 205, the RAN node 207, the user equipment apparatus 700, the network apparatus 800, and/or another wireless endpoint device, as described above. The first apparatus includes a processor coupled to a transceiver, the transceiver configured to communicate with a second endpoint (e.g., a UE) over a wireless channel and the processor configured to cause the first apparatus to: A) generate a security key (e.g., K_{d}) using channel information of the wireless channel: B) compute a first authentication code (e.g., a MAC-I) over a first Training Sequence (e.g., Sequence A) using the security key: C) send the first Training Sequence including the first authentication code to the second endpoint: D) receive a response message from the second endpoint, the response message including a second authentication code (e.g., a MAC-I): E) validate the second authentication code: and F) indicate successful key establishment in response to successful validation of the second authentication code.

In some embodiments, the processor is further configured to cause the apparatus to: A) perform channel estimation (e.g., measurements) of the wireless channel: B) extract channel parameters from the channel estimation: and C) quantize the extracted channel parameters to obtain the channel information. In such embodiments, to generate the security key, the processor is configured to input a plurality of quantized channel parameters to a key derivation function.

In some embodiments, the response message includes a second Training Sequence (e.g., Sequence B) different than the first Training Sequence, wherein the response message indicates successful key verification by the second endpoint. In certain embodiments, to validate the second authentication code, the processor is further configured to cause the apparatus to: A) compute a third authentication code (e.g., a MAC-I) over the second Training Sequence, using the previously generated security key (e.g., K_{d}): B) compare the computed third authentication code with the second authentication code received from the second endpoint: and C) indicate successful key establishment when the third authentication code is equal to the second authentication code.

In some embodiments, the response message includes the first Training Sequence (e.g., Sequence A) encrypted using the security key, where the response message indicates successful key verification by the second endpoint. In certain embodiments, to validate the second authentication code, the processor is further configured to cause the apparatus to: A) compute a third authentication code (e.g., a MAC-I) over the encrypted first Training Sequence, using the previously generated security key (e.g., K_{d}): B) compare the computed third authentication code with the second authentication code received from the second endpoint: and C) indicate successful key establishment when the third authentication code is equal to the second authentication code.

In some embodiments, the response message indicates key verification failure by the second endpoint and the response message includes the first Training Sequence (e.g., Sequence A). In such embodiments, the processor is further configured to cause the apparatus to: A) determine updated channel information of the wireless channel: B) generate a second security key (e.g., K_{d}*) using the updated channel information of the wireless channel: C) compute a third authentication code (e.g., a MAC-I) over the first Training Sequence using the second security key: D) compare the computed third authentication code with the second authentication code received from the second endpoint: and E) indicate successful key establishment when the third authentication code is equal to the second authentication code.

In certain embodiments, to indicate successful key establishment, the processor is further configured to cause the apparatus to: A) compute a fourth authentication code (e.g., a MAC-I) over a second Training Sequence (e.g., Sequence B) using the second security key, the second Training Sequence being different than the first Training Sequence: and B) send the second Training Sequence including the fourth authentication code to the second endpoint, where the second Training Sequence indicates successful key verification by the first endpoint.

Disclosed herein is a first method for physical layer secret key generation, according to embodiments of the disclosure. The first method may be performed by a first endpoint, such as a remote unit 105, a base unit 121, a UE 205, a RAN node 207, the user equipment apparatus 600, a network apparatus 700, and/or another wireless endpoint device, described above. The first method includes generating a security key (e.g., K_{d}) using channel information of a wireless channel and computing a first authentication code (e.g., a MAC-I) over a first Training Sequence (e.g., Sequence A) using the security key. The first method includes sending the first Training Sequence including the first authentication code to a second endpoint and receiving a response message from the second endpoint, the response message including a second authentication code (e.g., a MAC-I). The first method includes validating the second authentication code and indicating successful key establishment in response to successful validation of the second authentication code.

In some embodiments, the first method includes performing channel estimation (e.g., measurements) of the wireless channel. Here, the first method further includes extracting channel parameters from the channel estimation: and quantizing the extracted channel parameters to obtain the channel information. In such embodiments, generating the security key includes inputting a plurality of quantized channel parameters to a key derivation function.

In some embodiments, the response message includes a second Training Sequence (e.g., Sequence B) different than the first Training Sequence, wherein the response message indicates successful key verification by the second endpoint. In certain embodiments, validating the second authentication code includes using the previously generated security key (e.g., K_{d}) to compute a third authentication code (e.g., a MAC-I) over the second Training Sequence and comparing the computed third authentication code with the second authentication code received from the second endpoint. In such embodiments, the first endpoint indicates successful key establishment when the third authentication code is equal to the second authentication code.

In some embodiments, the response message includes the first Training Sequence (e.g., Sequence A) encrypted using the previously generated security key (e.g., K_{d}), wherein the response message indicates successful key verification by the second endpoint. In certain embodiments, validating the second authentication code includes using the previously generated security key to compute a third authentication code (e.g., a MAC-I) over the encrypted first Training Sequence and comparing the computed third authentication code with the second authentication code received from the second endpoint. In such embodiments, the first endpoint indicates successful key establishment when the third authentication code is equal to the second authentication code.

In some embodiments, the response message indicates key verification failure by the second endpoint and the response message includes the first Training Sequence (e.g., Sequence A). In such embodiments, the first method further includes determining updated channel information of the wireless channel and generating a second security key (e.g., K_{d}*) using the updated channel information of the wireless channel. Here, the first endpoint validates the second authentication code by computing a third authentication code (e.g., a MAC-I) over the first Training Sequence using the second security key and comparing the computed third authentication code with the second authentication code received from the second endpoint. In such embodiments, the first endpoint indicates successful key establishment when the third authentication code is equal to the second authentication code.

In certain embodiments, indicating successful key establishment includes computing a fourth authentication code (e.g., a MAC-I) over a second Training Sequence (e.g., Sequence B) using the second security key and sending the second Training Sequence including the fourth authentication code to the second endpoint. In such embodiments, the second Training Sequence is different than the first Training Sequence, where the second Training Sequence indicates successful key verification by the first endpoint.

Disclosed herein is a second apparatus for configuring a service gap time for a terminal (e.g., a UE) in a communication network (e.g., NW-A), according to embodiments of the disclosure. The second apparatus may be implemented by a second endpoint, such as a remote unit 105, a base unit 121, a UE 205, a RAN node 207, the user equipment apparatus 600, a network apparatus 700, and/or another wireless endpoint device, described above. The second apparatus includes a processor coupled to a transceiver, the transceiver configured to communicate with a first endpoint (e.g., a UE) over a wireless channel and the processor configured to cause the second apparatus to: A) receive a first Training Sequence including a first authentication code (e.g., a MAC-I) from the first endpoint: B) generate a security key (e.g., K_{d}*) using channel information of the wireless channel: C) validate the first authentication code using the generated security key; D) indicate successful key establishment in response to successful validation of the first authentication code: E) compute a second authentication code (e.g., a MAC-I) over a second Training Sequence: and F) send a response message to the first endpoint, the response message including the second authentication code.

In some embodiments, the processor is further configured to cause the apparatus to: A) perform channel estimation (e.g., measurements) of the wireless channel: B) extract channel parameters from the channel estimation: and C) quantize the extracted channel parameters to obtain the channel information. In such embodiments, to generate the security key, the processor is configured to input a plurality of quantized channel parameters to a key derivation function.

In some embodiments, to validate the first authentication code, the processor is further configured to cause the apparatus to: A) compute a third authentication code (e.g., a MAC-I) over the second Training Sequence, using the previously generated security key (e.g., K_{d}*): B) compare the computed third authentication code with the first authentication code received from the first endpoint: and C) indicate successful key establishment when the third authentication code is equal to the first authentication code.

In certain embodiments, the response message includes a second Training Sequence (e.g., Sequence B) different than the first Training Sequence, where the response message indicates successful key verification by the second endpoint. In certain embodiments, the response message includes the first Training Sequence (e.g., Sequence A) encrypted using the security key (e.g., K_{d}*), where the response message indicates successful key verification by the second endpoint.

In some embodiments, the response message indicates key verification failure by the second endpoint. In such embodiments, the processor is further configured to cause the apparatus to: A) determine updated channel information of the wireless channel in response to unsuccessful validation of the first authentication code: B) generate a second security key (e.g., K_{d}) using the updated channel information of the wireless channel: and C) compute the second authentication code over the first Training Sequence (e.g., Sequence A) using the second security key. Here, the wherein the response message includes the first Training Sequence.

In certain embodiments, the processor is further configured to cause the apparatus to: A) receive a second response message from the first endpoint, the second response message including a third authentication code (e.g., a MAC-I): B) validate the third authentication code; and C) indicate successful key establishment in response to successful validation of the third authentication code.

Disclosed herein is a second method for configuring a service gap time for a terminal (e.g., a UE) in a communication network (e.g., NW-A), according to embodiments of the disclosure. The second method may be performed by a second endpoint, such as a remote unit 105, a base unit 121, a UE 205, a RAN node 207, the user equipment apparatus 600, a network apparatus 700, and/or another wireless endpoint device, described above. The second method includes receiving a first Training Sequence including a first authentication code (e.g., a MAC-I) from the first endpoint and generating a security key (e.g., K_{d}*) using channel information of the wireless channel. The second method includes validating the first authentication code using the generated security key and indicating successful key establishment in response to successful validation of the first authentication code. The second method includes computing a second authentication code (e.g., a MAC-I) over a second Training Sequence and sending a response message to the first endpoint, the response message comprising the second authentication code.

In some embodiments, the second method further includes performing channel estimation (e.g., measurements) of the wireless channel. The second method includes extracting channel parameters from the channel estimation and quantizing the extracted channel parameters to obtain the channel information. In such embodiments, generating the security key includes inputting a plurality of quantized channel parameters to a key derivation function.

In some embodiments, validating the first authentication code include computing a third authentication code (e.g., a MAC-I) over the second Training Sequence, using the previously generated security key (e.g., K_{d}*), and comparing the computed third authentication code with the first authentication code received from the first endpoint. In such embodiments, the second method includes indicating successful key establishment when the third authentication code is equal to the first authentication code.

In certain embodiments, the response message also includes a second Training Sequence (e.g., Sequence B) different than the first Training Sequence, where the response message indicates successful key verification by the second endpoint. In other embodiments, the response message includes an encrypted version of the first Training Sequence (e.g., Sequence A) that was encrypted using the previously generated security key (e.g., K_{d}*), where the response message also indicates successful key verification by the second endpoint.

In some embodiments, the response message indicates key verification failure by the second endpoint. In such embodiments, the second method may further include determining updated channel information of the wireless channel (i.e., in response to unsuccessful validation of the first authentication code), generating a second security key (e.g., K_{d}) using the updated channel information of the wireless channel, and computing the second authentication code over the first Training Sequence using the second security key. Here, the response message includes the first Training Sequence.

In certain embodiments, the second method further includes receiving, from the first endpoint, a second response message containing a third authentication code (e.g., a MAC-I) and validating the third authentication code. In such embodiments, the second method includes indicating successful key establishment in response to successful validation of the third authentication code.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a first endpoint device, the method comprising:
generating a security key using channel information of a wireless channel;
computing a first authentication code over a first Training Sequence using the security key;
sending the first Training Sequence including the first authentication code to a second endpoint;
receiving a response message from the second endpoint, the response message including a second authentication code;
validating the second authentication code; and
indicating successful key establishment in response to successful validation of the second authentication code.

2. The method of claim 1, further comprising:
performing channel estimation of the wireless channel;
extracting channel parameters from the channel estimation; and
quantizing the extracted channel parameters to obtain the channel information,
wherein generating the security key comprises inputting a plurality of quantized channel parameters to a key derivation function.

3. The method of claim 1, wherein the response message comprises a second Training Sequence different than the first Training Sequence, wherein the response message indicates successful key verification by the second endpoint.

4. The method of claim 3, wherein validating the second authentication code comprises:
computing a third authentication code over the second Training Sequence, using the previously generated security key;
comparing the computed third authentication code with the second authentication code received from the second endpoint; and
indicating successful key establishment when the third authentication code is equal to the second authentication code.

5. The method of claim 1, wherein the response message comprises the first Training Sequence encrypted using the security key, wherein the response message indicates successful key verification by the second endpoint.

6. The method of claim 1, wherein the response message comprises the first Training Sequence, the method further comprising:
determining updated channel information of the wireless channel;
generating a second security key using the updated channel information of the wireless channel;
computing a third authentication code over the first Training Sequence using the second security key;
comparing the computed third authentication code with the second authentication code received from the second endpoint; and
indicating successful key establishment when the third authentication code is equal to the second authentication code.

7. The method of claim 6, wherein indicating successful key establishment comprises
computing a fourth authentication code over a second Training Sequence using the second security key, the second Training Sequence being different than the first Training Sequence; and
sending the second Training Sequence including the fourth authentication code to the second endpoint,
wherein the second Training Sequence indicates successful key verification by the first endpoint.

8. A first endpoint apparatus comprising:
a transceiver configured to communicate with a second endpoint over a wireless channel; and
a processor coupled to the transceiver, the processor configured to cause the apparatus to:
generate a security key using channel information of the wireless channel;
compute a first authentication code over a first Training Sequence using the security key;
send the first Training Sequence including the first authentication code to the second endpoint;
receive a response message from the second endpoint, the response message including a second authentication code;
validate the second authentication code; and
indicate successful key establishment in response to successful validation of the second authentication code.

9. A second endpoint apparatus comprising:
a transceiver configured to communicate with a first endpoint over a wireless channel; and
a processor coupled to the transceiver, the processor configured to cause the apparatus to:
receive a first Training Sequence including a first authentication code from the first endpoint;
generate a security key using channel information of the wireless channel;
validate the first authentication code using the generated security key;
indicate successful key establishment in response to successful validation of the first authentication code;
compute a second authentication code over a second Training Sequence; and
send a response message to the first endpoint, the response message comprising the second authentication code.

10. The apparatus of claim 9, wherein the processor is further configured to cause the apparatus to:
perform channel estimation of the wireless channel;
extract channel parameters from the channel estimation; and
quantize the extracted channel parameters to obtain the channel information,
wherein, to generate the security key, the processor is configured to input a plurality of quantized channel parameters to a key derivation function.

11. The apparatus of claim 9, wherein, to validate the first authentication code, the processor is further configured to cause the apparatus to:
compute a third authentication code over the second Training Sequence, using the previously generated security key;
compare the computed third authentication code with the second authentication code received from the second endpoint; and
indicate successful key establishment when the third authentication code is equal to the second authentication code.

12. The apparatus of claim 11, wherein the response message comprises a second Training Sequence different than the first Training Sequence, wherein the response message indicates successful key verification by the second endpoint.

13. The apparatus of claim 11, wherein the response message comprises the first Training Sequence encrypted using the security key, wherein the response message indicates successful key verification by the second endpoint.

14. The apparatus of claim 9, wherein the response message indicates key verification failure by the second endpoint, wherein the processor is further configured to cause the apparatus to:
determine updated channel information of the wireless channel in response to unsuccessful validation of the first authentication code;
generate a second security key using the updated channel information of the wireless channel;
compute the second authentication code over the first Training Sequence using the second security key,
wherein the response message includes the first Training Sequence.

15. The apparatus of claim 14, wherein the processor is further configured to cause the apparatus to:
receive a second response message from the first endpoint, the second response message including a third authentication code;
validate the third authentication code; and
indicate successful key establishment in response to successful validation of the third authentication code.
